(19) United States
(12) Patent Application Publication
(10) Pub. No.: US 2005/0170785 A1
(43) Pub. Date: Aug. 4, 2005

(54) Wireless transmitting and/or receiving system and method of sharing analog information

(76) Inventors: Bong-ki Jang, Suwon-si (KR); Sung-gi Kim, Suwon-si (KR); Young-sang Kim, Suwon-si (KR); Hong-sik Park, Suwon-si (KR); Doo-hee Lee, Suwon-si (KR); Jun-ho Seong, Pyungtaek-si (KR); Hye-jin Kim, Yongin-si (KR)

Correspondence Address: STANZIONE & KIM, LLP, 1740 N STREET, N.W., FIRST FLOOR, WASHINGTON, DC, 20036, US

(21) Appl. No.: 11/003,977

(22) Filed: Dec. 6, 2004

(30) Foreign Application Priority Data
Jan. 30, 2004 (KR) 2004-6125

(51) Int. Cl. H04B 17/00

(52) U.S. Cl. 455/67.14; 455/73

(57) ABSTRACT

A wireless transmitting and/or receiving system and method of sharing analog information between a transmitter and a receiver connected to the transmitter by a wireless channel. The wireless transmitting and/or receiving system includes a transmitter that extracts analog signal and information from an analog broadcast signal, converts the analog signal into a transport stream that is then sent to a first wireless channel, transmits the analog information to a second wireless channel when the analog information is extracted, and updates previously stored first analog information with the received analog information, and a receiver that decodes the transport stream received from the transmitting means via the first wireless channel and updates previously stored second analog information with the analog information received by the second wireless channel.

### CROSS-REFERENCE TO RELATED APPLICATIONS

This application claims the priority of Korean Patent Application No. 2004-6125, filed on Jan. 30, 2004, in the Korean Intellectual Property Office, the disclosure of which is incorporated herein in its entirety by reference.

### BACKGROUND OF THE INVENTION

1. Field of the Invention

The present general inventive concept relates to a wireless transceiver system, and more particularly, to a wireless transmitting and/or receiving system and method of sharing analog information between a transmitter and a receiver connected to the transmitter by a wireless channel.

2. Description of the Related Art

A typical wireless transmitting/receiving system includes a transmitter and a receiver connected to the transmitter by a wireless channel. For example, when the transmitter is a set-top box (STB) and a receiver is a television set, the STB encodes digital or analog broadcast signals according to an Advanced Television Sub-Committee (ATSC) or MPEG format. In this case, when the analog broadcast signals are tuned, the STB uses an analog decoder to extract analog information, such as caption and stereo/mono information, to be displayed to a user. The television set decodes the digital broadcast signals received from the STB and outputs the decoded video or audio signal to a screen or speaker. The television set may be placed away from the STB with a wall disposed therebetween. For example, the STB and the television set may be installed in a living room and an inner chamber, respectively. Further, the STB and the television set are equipped with remote controllers, which allow the user to remotely control various functions thereof.

In this case, the STB is able to tune the analog broadcast signals, such as National Television Systems Committee (NTSC) signals, as well as digital broadcast signals. Thus, the STB uses the analog decoder to view the analog information, such as caption and stereo/mono information. However, since the television set wirelessly receives the broadcast signals in the ATSC or MPEG format from the STB, which does not define a format for applying the analog information, it does not contain an analog information decoder. Thus, it is impossible for the user to view the analog information on the television set wirelessly connected to the STB.

### SUMMARY OF THE INVENTION

The present general inventive concept provides a wireless transmitting/receiving system and method of sharing analog information between transmitter and receiver connected by a wireless channel.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a wireless transmitting/receiving system including, a transmitter that extracts analog signal and information from an analog broadcast signal, converts the analog signal into a transport stream that is then sent to a first wireless channel, transmits the analog information to a second wireless channel when the analog information is extracted, and updates the previously stored analog information with the received analog information, and a receiver that decodes the transport stream received from the transmitting means via the first wireless channel and updates the previously stored analog information when the analog information is received by the second wireless channel.

The foregoing and/or other aspects and advantages of the present general inventive concept may also be achieved by providing a method of sharing analog information in a wireless transmitting/receiving system including a transmitter and a receiver connected by a wireless local area network (LAN), the method including extracting analog signal and information from an analog broadcast signal, encoding the analog signal for transmission to a first wireless channel, transmitting the analog information to a second wireless channel when the same information is extracted, updating the previously stored analog information with the received analog information, and decoding the encoded signal received by the first wireless channel and updating the previously stored analog information when the analog information is received by the second wireless channel.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a wireless transmitting and/or receiving system according to an embodiment of the present general inventive concept;

FIG. 2 is a detailed diagram illustrating a transmitter shown in FIG. 1;

FIG. 3 is a detailed diagram illustrating a receiver shown in FIG. 1;

FIG. 4 is a flowchart illustrating a method of sharing analog information in a transmitter according to another embodiment of the present general inventive concept; and

FIG. 5 is a flowchart illustrating a method of sharing analog information in a receiver according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

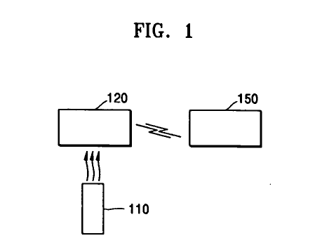

Referring to FIG. 1, a wireless transmitting and/or receiving system may include a transmitter 120 and a receiver 150. A remote controller 110 issues generates a control command to the transmitter 120 and controls various operation features. The transmitter 120 communicates with the receiver 150 via a wireless channel. For example, if the transmitter may be placed in a living room, the receiver 150 may be installed in a bedroom, kitchen, or living room away from the transmitter 120. Furthermore, the transmitter 120 and the receiver 150 equipped with wireless transmitting and/or receiving modules can transmit and receive various signals via a wireless local area network (WLAN) using a 5 GHz frequency band or a 430 MHz frequency band, respectively.

The transmitter 120 extracts analog signal and information from an analog broadcast signal, converts the analog signal into a transport stream that is then sent through a first wireless channel, transmits the analog information through a second wireless channel when the analog information is extracted, and updates previously stored analog information with the extracted analog information. The receiver 150 decodes the transport stream received from the transmitter 120 via the first wireless channel into video/audio and updates the previously stored analog information with the analog information received via the second wireless channel.

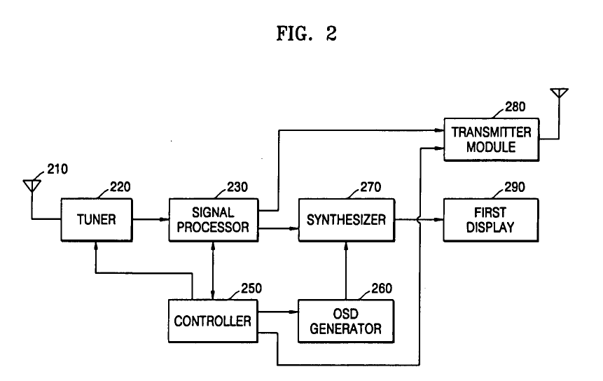

Referring to FIG. 2, a tuner 220 receives an Advanced Television Sub-Committee (ATSC)-compliant digital TV (DTV) signal or a National Television Systems Committee (NTSC)-compliant analog TV signal. The tuner 220 then tunes the NTSC analog TV and/or ATSC DTV signal received from an antenna 210 in response to a tune command signal generated by a controller 250.

A signal processor 230 extracts a transport stream and an analog video/audio signal from the ATSC-DTV signal or the NTSC analog TV signal output from the tuner 220, respectively. In addition, the signal processor 230 detects analog information from a vertical blanking interval (VBI) or a pilot signal contained in the analog TV signal. In this case, the signal processor 230 converts the analog video/audio signal into another transport stream, for example, MPEG transport stream, according to an encoding control signal of a controller 250.

The controller 250 outputs tuning data to the tuner 220, generates a key code corresponding to a function control command of the remote controller 110, and stores the analog information, such as caption or stereo information, extracted by the signal processor 230 in a register. In this case, the analog information is represented as a predetermined status value. For example, the caption and stereo information may be expressed by “11” and “10”, respectively. Furthermore, when the analog information is extracted, the controller 250 outputs a value corresponding to the analog information to a transmitter module 280 and then updates a previous status value with the output value of the analog information. An OSD generator 260 generates OSD information corresponding to the key code generated by the controller 250. A synthesizer 270 combines the video signal generated by the signal processor 230 with the OSD information generated by the OSD generator 260. A first display 290 displays the video signal and the OSD information received from the synthesizer 270 on a cathode ray tube (CRT) or a flat panel screen (not shown).

A transmitter module 280 modulates the transport stream or the another transport stream processed by the signal processor 230 and the analog information generated by the controller 250 into first and second wireless signals to be transmitted through different channels. For example, the transport stream and the analog information are transmitted in a form of an Orthogonal Frequency Division Multiplexer (OFDM) signal using the 5 GHz frequency band or in a format of an RF signal using the 430 MHz frequency band, respectively.

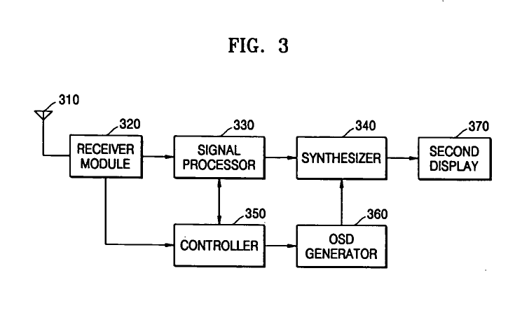

FIG. 3 is a detailed diagram of the receiver 150 of FIG. 1. Referring to FIGS. 1 through 3, a receiver module 320 separates the transport stream and the analog information from 5 GHz and 430 MHz wireless signals for demodulation. A signal processor 330 decodes the transport stream output from the receiver module 320 into video (R, G, B) and audio signals, receives a function control command from the controller 350, and manipulates the video and audio signals.

A controller 350 extracts the analog information from an RF signal received from the receiver module 320 and generates a key code corresponding to a feature control command issued by a remote controller. In particular, when the analog information is received via a wireless channel, the controller 350 updates an analog information value stored in a register with the received analog information. An OSD generator 360 generates OSD information corresponding to the key code generated by the controller 350. A synthesizer 340 combines the video signal generated by the signal processor 330 with the OSD information generated by the OSD generator 360. A second display 370 displays the video signal and OSD information received from the synthesizer 340 on a CRT or a flat panel display (not shown).

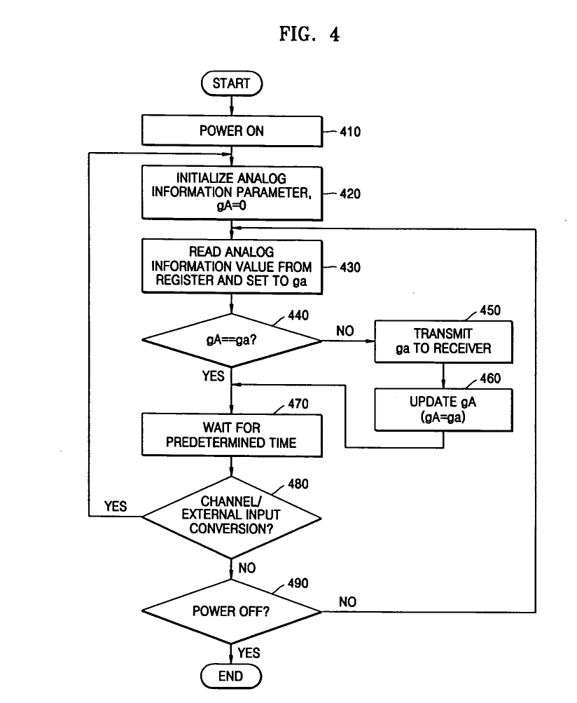

FIG. 4 is a flowchart illustrating a method of sharing analog information in a transmitter according to another embodiment of the present general inventive concept. First, in operation 420, when a transmitter is turned on, predefined analog information parameters are initialized. For example, if caption and audio information parameters are set to gA and gB, respectively, gA=0 and gB=0. When analog information is extracted from a broadcast signal, the same information is stored in a register. In operation 430, a status value of the analog information stored in the register is read and set as a new parameter. For example, if the status value represents caption information, ga is then replaced with the status value.

Then, in operation 440, the previously set analog information parameter is compared to the analog information parameter currently received. For example, it is checked whether the previous caption information parameter gA is identical to the currently decoded analog information parameter ga. In operation 450, when the previous caption information parameter gA is not identical to the currently decoded analog information parameter ga, the parameter ga is transmitted to a receiver via a different wireless channel separately from video/audio signals, and the parameter gA is updated with the parameter ga in operation 460. Conversely, when the parameters gA and ga are identical to each other, the transmitter waits for a predetermined period of time to reduce an overhead (overload) of a central processor unit (CPU) in operation 470.

In operation 480, it is checked whether a channel conversion or external input conversion signal is generated. When the channel conversion or external input conversion signal is present, the operations 420 through 470 are repeated. Conversely, when the channel conversion or external input conversion signal does not occur, it is checked whether a power is turned off in operation 490. When the power is turned on, the operations 430 through 480 are repeated while a process of sharing analog information terminates when the power is turned off.

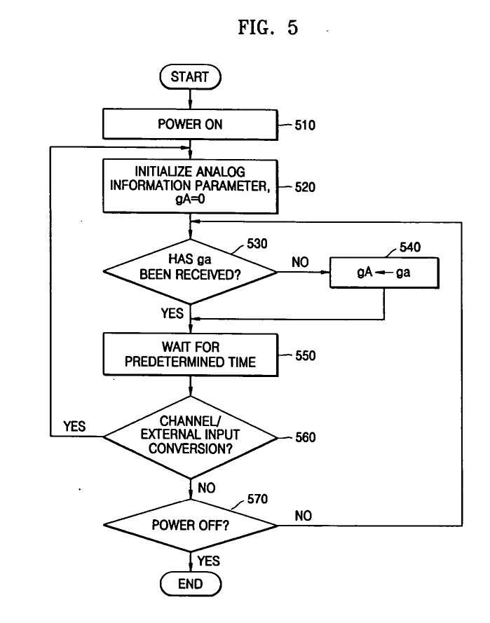

FIG. 5 is a flowchart illustrating a method of sharing analog information in a receiver according to another embodiment of the present general inventive concept. First, in operation 520, when the receiver is turned on, predefined analog information parameters are initialized. For example, caption and audio information parameters can be set to gA and gB, respectively. Then, in operation 530, it is checked whether a parameter value ga of the currently decoded analog information has been received from a transmitter via a wireless channel. In this case, when the parameter value has been received, the preset analog information parameter is updated with the received parameter value. That is, in operation 540, the preset caption information parameter gA is replaced with the parameter value ga of the currently decoded analog information.

Conversely, when the parameter value has not been received, the receiver waits for a predetermined period of time to reduce an overhead (overload) of a CPU in operation 550. In operation 560, it is checked whether a channel conversion or external input conversion signal is generated. When the channel conversion or external input conversion signal is present, the operations 510 through 550 are repeated. When the channel conversion or external input conversion signal does not occur, it is checked whether a power is turned off in operation 570. When the power is turned on, the operations 530 through 560 are repeated while a process of sharing analog information terminates when the power is turned off.

A wireless transmitting/receiving system according to the present general inventive concept enables a receiver to store analog information synchronized with a transmitter and to display the same information on a screen as manipulated by a user. The system also allows the receiver that receives only ATSC signals to share the same analog information with the transmitter.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wireless transmitting and/or receiving system comprising:
a transmitter that extracts analog signal and information from an analog broadcast signal, converts the analog signal into a transport stream to be sent through a first wireless channel, transmits the analog information through a second wireless channel, and updates previously stored first analog information with the extracted analog information; and
a receiver that decodes the transport stream received from the transmitter via the first wireless channel and updates previously stored second analog information with the received analog information.

2. The system of claim 1, wherein the transmitter comprises:
a signal processor that extracts another transport stream and an analog video/audio signal and analog information from a digital broadcast signal and the analog broadcast signal, respectively, and encodes the analog video/audio signal into the transport stream;
a controller that stores a status value representing the previously stored first analog information extracted by the signal processor, outputs the analog information when the analog information is extracted, and updates the status value of the previously stored first analog information with the output analog information; and
a transmitter module that modulates the transport stream or the another transport stream processed by the signal processor and the analog information generated by the controller into first and second wireless signals and transmits the first and second wireless signals through the first and second wireless channels.

3. The system of claim 1, wherein the receiver comprises:
a receiver module that separates the transport stream and the analog information from a RF signal received as first and second wireless signals;
a signal processor that decodes the transport stream separated by the receiver module into video/audio signals; and
a controller that extracts the analog information from the RF signal of the receiver module and updates a status value of the previously stored second analog information with the extracted analog information when the analog information is received.

4. The system of claim 1, wherein the transmitter and the receiver communicate with each other through a wireless local area network using the first wireless channel and the second wireless channel.

5. The system of claim 1, wherein the first wireless channel and the second wireless channel have different frequency bands.

6. The system of claim 1, wherein the transmitter comprises a set top box, and the receiver comprises a television set.

7. A method of sharing analog information in a wireless transmitting and/or receiving system including a transmitter and a receiver connected by a wireless local area network (LAN), the method comprising:
extracting analog signal and information from an analog broadcast signal, encoding the analog signal into a transport stream to be transmitted through a first wireless channel, transmitting the analog information through a second wireless channel when the analog signal and information are extracted, and updating previously stored first analog information with the extracted analog information; and
decoding the encoded signal received through the first wireless channel, receiving the transmitted analog information through the second wireless channel, and updating previously stored second analog information with the received analog information when the analog information is received through the second wireless channel.

8. The method of claim 7, wherein the updating of the previously stored first analog information with the extracted analog information when transmitting the extracted analog information through the second wireless channel, comprises:
storing the extracted analog information in a register when the analog information is extracted from the analog broadcast signal;
reading a status value of the stored analog information stored in the register and setting the status value as a new parameter; and
when a preset analog information parameter is not identical to the status value of the extracted analog information, transmitting the extracted analog information through the second wireless channel separately from the first wireless channel, and updating the preset analog information parameter with the status value of the extracted analog information.

9. The method of claim 7, wherein the updating of the previously stored second analog information comprises updating a preset analog information with the received analog information when the analog information is received through the second wireless channel.

10. A transmitter used with a wireless transmitting and/or receiving system, comprising:
a signal processor to extract an analog signal and analog information from an analog broadcast signal, to encode the analog signal into a transport stream, and to extract another transport stream from a digital broadcast signal;
a controller to store a status value corresponding to the analog information; and
a transmitter module to modulate the analog information and at least one of the transport stream and the another transport stream using a first wireless channel and a second wireless channel, respectively.

11. The transmitter of claim 10, further comprising:
a tuner connected to the signal processor to receive the analog broadcast signal and the digital broadcast signal and the digital broadcast signal through an antenna.

12. The transmitter of claim 10, further comprising:
an OSD generator to generate OSD information according to a function control command from an external controller; and
a synthesizer to combine the OSD information with a video signal corresponding to the at least one of the transport stream and the another transport stream.

13. The transmitter of claim 10, wherein the analog signal extracted from the analog broadcast signal comprises a video signal and an audio signal, and the analog information comprises information detected from at least one of a vertical blanking interval and a pilot signal contained in the analog broadcast signal.

14. The transmitter of claim 10, wherein the signal processor, the controller, and the transmitter module are installed in a set top box.

15. The transmitter of claim 10, wherein the first wireless channel comprises a first frequency band higher than a second frequency band of the second wireless channel.

16. The transmitter of claim 10, wherein the first wireless channel comprises a 5 GHz frequency band, and the second wireless channel comprises a 430 MHz frequency band.

17. The transmitter of claim 10, wherein the transmitter module outputs an OFDM signal corresponding to the first wireless channel and an RF signal corresponding to the second wireless channel.

18. The transmitter of claim 10, wherein the transmitter module outputs the first wireless channel and the second wireless channel simultaneously.

19. The transmitter of claim 10, wherein the controller stores a previously stored analog information parameter in a memory and updates the previously stored analog information parameter with a status value of the analog information.

20. The transmitter of claim 10, wherein the analog broadcast signal comprises an NTSC-compliant analog TV signal, and the digital broadcast signal comprises an ATSC-compliant digital TV signal.

21. A receiver used with a wireless transmitting and/or receiving system, comprising:
a receiver module to separate a transport stream and analog information received through a first wireless channel and a second wireless channel, respectively;
a signal processor to decode the transport stream into a video signal and an audio signal; and
a controller to update a previously stored analog information with the analog information transmitted from the receiver module, and to generate a key code corresponding to OSD information.

22. The receiver of claim 21, further comprising:
an OSD generator to generate the OSD information according to the key code of the controller; and
a synthesizer to combine the video signal with the OSD information.

23. The receiver of claim 21, further comprising:
an antenna to receive the first wireless channel having a higher frequency band than that of the second wireless channel.

24. The receiver of claim 21, wherein the receiver module, the signal processor, and the controller are installed in a television set.

25. The receiver of claim 21, wherein the receiver module receives a 5 GHz frequency band signal as the first wireless channel and a 430 MHz frequency band signal as the second wireless channel.

26. The receiver of claim 21, wherein the receiver module receives an OFDM signal corresponding to the first wireless channel and an RF signal corresponding to the second wireless channel.

27. A wireless transmitting and/or receiving system comprising:
a transmitter that extracts analog signal and information from an analog broadcast signal, converts the analog signal into a transport stream to be sent through a first wireless channel, transmits the analog information through a second wireless channel, and updates previously stored analog information with the extracted analog information.

28. A wireless transmitting and/or receiving system comprising:
a receiver that decodes a transport stream received through a first wireless channel and updates a previously stored analog information with analog information received through a second channel.
